(19) United States
(12) Patent Application Publication
(10) Pub. No.: US 2018/0216527 A1
(43) Pub. Date: Aug. 2, 2018

(54) RADIAL VARIABLE INLET GUIDE VANE FOR AXIAL OR AXI-CENTRIFUGAL COMPRESSORS

(71) Applicant: General Electric Company, Schenectady, NY (US)

(72) Inventors: Martin Miles D'Angelo, Boston, MA (US); Mark Gregory Wotzak, Chestnut Hill, MA (US); Michael Macrorie, Winchester, MA (US)

(21) Appl. No.: 15/417,937

(22) Filed: Jan. 27, 2017

(51) Int. Cl. F02C 7/042; F02C 3/04; F01D 25/30; F04D 29/32; F04D 29/54; F04D 29/56

(52) U.S. Cl. CPC F02C 7/042; F02C 3/04; F01D 25/30; F04D 29/321; F05D 2240/35; F04D 29/542; F04D 29/563; F05D 2220/32; F04D 29/545

(57) ABSTRACT

A turbine engine includes, in a serial flow relationship, an axially oriented compressor, a combustion section, a turbine section, and an exhaust section. An air flowpath extends from an inlet duct to the exhaust section such that the compressor, combustion section, turbine, and the exhaust section are in fluid communication. The inlet duct is positioned upstream of the compressor and defines an inlet portion of the air flowpath. The inlet duct is generally radially oriented. A variable inlet guide vane extends at least partially through the inlet duct.

### FIELD

The present subject matter relates generally to gas turbine engines. More particularly, the subject matter relates to axial and axi-centrifugal compressors for gas turbine engines.

### BACKGROUND

An exemplary gas turbine engine may include a propeller or fan and a core arranged in axial flow communication. The core of the gas turbine engine generally includes, in serial flow order, a compressor section, a combustion section, a turbine section, and an exhaust section. In operation, ambient air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The turbine section extracts energy from the expanding combustion gas and drives the compressor section via a shaft or shafts. Expanded combustion products are exhausted downstream through the exhaust section, e.g., to the atmosphere.

Gas turbine engines normally include inlets configured to receive and direct airflow to the compressor. A number of gas turbine engines include radial inlets. In a radial inlet configuration, the inlet is oriented generally radially with respect to the generally axially oriented compressor.

In the past, gas turbine engines having axially oriented compressors with radial inlets have included fixed/stationary inlet guide vanes (IGV) and/or struts positioned within the radial inlet. IGVs can be used to modify the airflow directed into the compressor to prevent downstream compressor rotor blades from stalling or surging, for example. In some cases, the radial inlet simply does not contain guide vanes at all.

In some instances, gas turbine engines having axially oriented cores and radial inlets may have variable inlet guide vanes (VIGVs) positioned adjacent to the compressor. VIGVs are employed to achieve compressor stability over a wide range of mass flow rates and operating speeds, among other benefits. VIGVs are typically axially oriented and positioned upstream of and usually very near or adjacent to the first rotor of the compressor. However, these configurations do not offer optimal inlet swirl profiles and can extend the axial length of the engine, increasing the weight, length, and cost of the engine.

Therefore, a gas turbine engine having an axial or axi-centrifugal compressor with a radial inlet configuration that has VIGVs adapted to modify the airflow into the compressor over a wide operating range while reducing the weight length, and/or cost of the gas turbine engine would be useful.

### BRIEF DESCRIPTION

Aspects and advantages of the invention will be set forth in part in the following description, or may be obvious from the description, or may be learned through practice of the invention.

One exemplary aspect of the present disclosure is directed to a turbine engine. The turbine engine defines an air flowpath, an axial direction, and a radial direction. The turbine engine includes a compressor having a plurality of rotors rotatable about the axial direction for pressurizing airflow. An inlet duct in airflow communication with the compressor is positioned upstream of the compressor. The inlet duct defines an inlet portion of the air flowpath and is oriented generally along the radial direction. A variable inlet guide vane extends at least partially through the inlet duct for modifying airflow through the inlet duct to the compressor.

Another exemplary aspect of the present disclosure is directed to a turbine engine defining an air flowpath, an axial direction, and a radial direction. The turbine engine includes a compressor having a plurality of rotors rotatable about the axial direction for pressurizing airflow. An inlet duct in airflow communication with the compressor is positioned upstream of the compressor. The inlet duct defines an inlet portion of the air flowpath and includes a radial section oriented generally along the radial direction and a transition section extending between the radial section and the compressor. The transition section configured to direct the airflow from generally along the radial direction to generally along the axial direction. A variable inlet guide vane configured to modify the airflow to the compressor defines a lengthwise direction extending generally parallel to the axial direction. The variable inlet guide vane extends in the lengthwise direction at least partially in the radial section and/or the transition section of the inlet duct.

In another exemplary embodiment, a turbine engine is provided. The turbine engine defines an air flowpath, an axial direction, and a radial direction. The turbine engine includes a compressor having a plurality of rotors rotatable about the axial direction for pressurizing airflow. A combustor is positioned downstream of the compressor along the air flowpath. A turbine is positioned downstream of the combustor along the air flowpath. In addition, an exhaust section is positioned downstream of the turbine along the air flowpath. An inlet duct in airflow communication with the compressor is positioned upstream of the compressor. The inlet duct defines an inlet portion of the air flowpath and is oriented generally along the radial direction. The inlet duct is defined by a forward wall and a rear wall extending along the inlet portion of the air flowpath. A variable inlet guide vane assembly having a plurality of vanes disposed circumferentially about a central axis disposed along the axial direction, each vane extends generally along the axial direction from the forward wall to the rear wall of the inlet duct.

Variations and modifications can be made to these exemplary aspects of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary turbine engine;

FIG. 2 is a close-up view of an annular inlet of the turbine engine of FIG. 1 having a variable inlet guide vane extending lengthwise through an inlet duct of the inlet;

FIG. 3 is a close-up view of an exemplary inlet duct having a variable inlet guide vane extending lengthwise through inlet duct and being positioned at or adjacent a mouth of the inlet;

FIG. 4 is a close-up view of an exemplary inlet duct having a variable inlet guide vane extending lengthwise through a curved transition portion;

FIG. 5 is a close-up view of an exemplary inlet duct having a variable inlet guide vane extending lengthwise through a parallel section of the duct;

FIG. 6 is a close-up view of another exemplary inlet duct having a variable inlet guide vane extending lengthwise through a parallel section of the duct;

FIG. 7 is a close-up view of an exemplary inlet duct having a variable inlet guide vane having its actuator being positioned aft of the duct;

FIG. 8 is a close-up view of an exemplary variable inlet guide vane having a flap;

FIG. 9 is a section view taken along the lines B-B of FIG. 8;

FIG. 10 is a close-up view of an exemplary variable inlet guide vane having a retractable curved member; and

FIG. 11 is a close-up view of an exemplary variable inlet guide vane configured to rotate about an axis of rotation.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the disclosed exemplary embodiments. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows and “downstream” refers to the direction to which the fluid flows. “HP” denotes high pressure and “LP” denotes low pressure. “Generally” means within at least about forty-five degrees (45°) of the noted direction or within at least about a forty-five percent (45%) margin of the noted amount, unless specifically stated otherwise. “Substantially” means within at least about ten degrees (10°) of the noted direction or within at least about a ten percent (10%) margin of the noted amount, unless specifically stated otherwise. “About” means at or within a ten percent (10%) margin of the noted amount or within manufacturing tolerances, whichever margin is greater.

Exemplary aspects of the present disclosure are directed to turbine engines having an axially oriented compressor and a radially oriented inlet in airflow communication with the compressor. In particular, aspects of the present disclosure are directed to turbine engines having axial or axi-centrifugal compressors with a radial inlet having one or more variable inlet guide vane(s) (VIGVs) extending therethrough. The one or more VIGVs modify airflow through the inlet duct of the radial inlet to the compressor.

One or more VIGVs extending through the inlet duct of a radial inlet has numerous advantages. For instance, where one or more VIGVs extend through a generally radially oriented inlet duct, VIGVs modify the airflow through the inlet duct in such a way that the compressor can achieve a higher axial pressure ratio (i.e., an improved compressor operating line), among other benefits, compared to a gas turbine engine having a radial inlet that does not include VIGVs. Also, where one or more VIGVs extend at least partially through a radially oriented inlet duct, there is little need for redundant axially oriented VIGVs; and consequently, the length and weight of the turbine engine can be reduced as little or no axial space is needed for the VIGVs.

Additionally, where the separation between a first rotor blade of the axially oriented compressor and one or more VIGVs is increased (i.e., where VIGVs are positioned further upstream of compressor), unfavorable interactions between VIGVs and first rotor blade of compressor are reduced. Moreover, increasing the distance of separation between first rotor blade and VIGVs allow for the airflow to be more developed as it reaches first rotor blade, providing better operability to turbine engine. Developing the swirl profile further upstream also advantageously means that VIGVs require reduced actuation to develop a particular swirl profile at first rotor blade, as once again, the swirl profile has more time to develop when VIGVs are placed further upstream of compressor and thus less deflection or modification of the airflow is required.

Yet another advantage of the increased separation between the VIGVs and the compressor is that the solidity of VIGVs can be reduced, either by reducing the number of vanes circumferentially disposed about the radial inlet or by reducing the chord length of each vane (i.e., reducing the distance from the leading edge of the vane to the trailing edge of the vane). Furthermore, in an embodiment where VIGVs are rotatable about a pivot axis (not shown), the amount of vane span-wise twist required to develop a given swirl profile at high speeds is also reduced.

Yet another advantage of one or more VIGVs extending through a generally radially oriented inlet duct is that the positioning of the VIGVs allows for an actuator configured to actuate the one or more VIGVs to be positioned either forward or aft of inlet duct.

A further advantage of one or more VIGVs extending through a generally radially oriented inlet duct is that VIGVs having variable geometry or configured to be rotatable about a pivot axis can still have minimal clearance with the walls or like structure of the inlet duct. In comparison, where VIGVs are axially oriented adjacent to the first rotor of the compressor, the walls of the inlet duct defining the air flowpath along the compressor are typically not parallel or substantially parallel to one another. In this way, axially oriented VIGVs may experience airflow leakage around each vane when the vanes are actuated in certain deflection positions. In radial inlets, a parallel section, or a section where the forward and rear walls of the duct extend parallel to one another along the inlet duct, may have VIGVs extending through this section. In this manner, the vane ends of each VIGV have minimal clearance with the forward and rear walls (or like structure) through substantially all deflection positions where the VIGVs are pivotable about a pivot axis, or where the VIGVs have variable geometry (e.g., a pivotable flap or a extending retractable member), the variable geometry of each VIGV does not interfere with the forward and rear walls of the inlet duct. Accordingly, where VIGVs extend in a parallel section of a radially oriented inlet duct, the clearance between the vane ends and the walls of the duct can be minimized to reduce airflow leakage around the vanes.

Further aspects and advantages of VIGVs extending through inlet duct will be apparent to those of skill in the art.

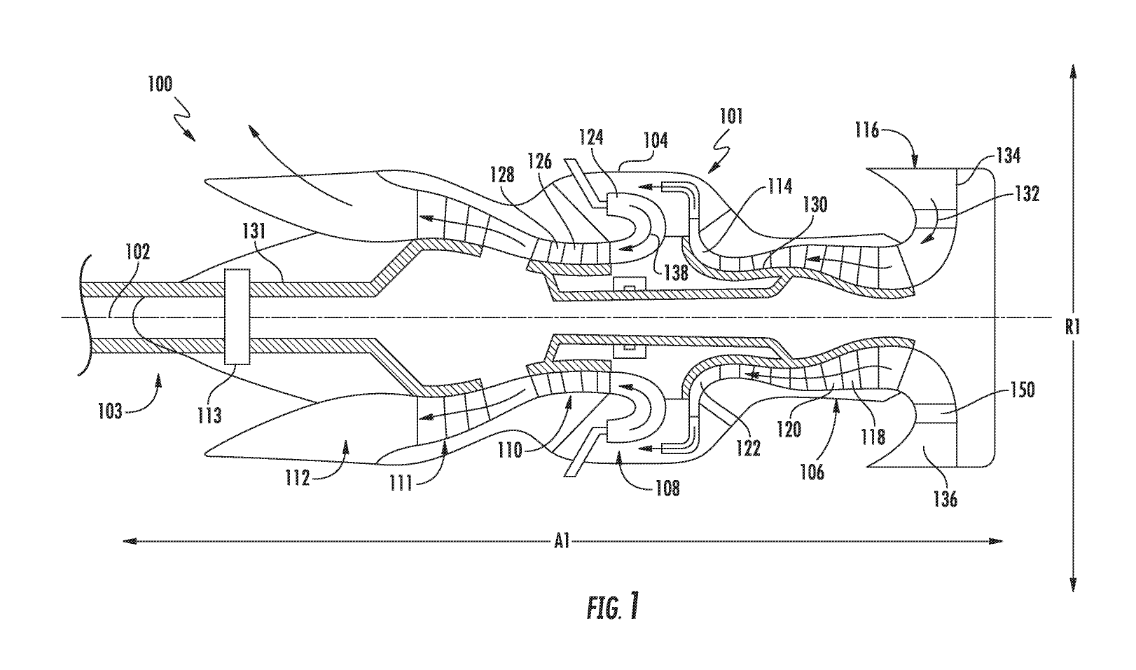

Turning now to the drawings, FIG. 1 is a schematic cross-sectional view of an exemplary gas turbine engine 100 in accordance with an exemplary embodiment of the present disclosure. Gas turbine engine 100 defines an axial direction A1 (extending parallel to a longitudinal centerline 102 provided for reference), a radial direction R1, and a circumferential direction (not shown) disposed about axial direction A1. Gas turbine engine 100 generally includes a core turbine engine 101 and an output shaft assembly 103 operable with, and driven by, core turbine engine 101.

Gas turbine engine 100 includes a substantially tubular outer casing 104 extending generally along axial direction A1. Outer casing 104 generally encloses gas turbine engine 100. Outer casing 104 may be formed from a single casing or multiple casings. Gas turbine engine 100 includes, in a serial flow relationship, a compressor 106, a combustion section 108, a HP turbine 110, a LP turbine 111 and an exhaust section 112. An air flowpath 114 extends from an annular inlet 116 to exhaust section 112 such that compressor 106, combustion section 108, turbine 110, and exhaust section 112 are in fluid communication.

Compressor 106 includes one or more sequential stages of compressor stator vanes 118, one or more sequential stages of compressor rotor blades 120, and an impeller 122. Combustion section 108 includes a combustor 124. HP turbine 110 includes one or more sequential stages of turbine stator vanes 126 and one or more sequential stages of turbine blades 128. A HP shaft 130 drivingly couples HP turbine 110 and compressor 106. Additionally, a LP shaft 131 drivingly couples LP turbine 111 to output shaft assembly 103 of gas turbine engine 100. LP shaft 34 is mechanically coupled to output shaft assembly 103 through gearbox 113. As will be appreciated, output shaft assembly 103 maybe coupled to any suitable device. For example, in certain exemplary embodiments, gas turbine engine 100 of FIG. 1 may be utilized to drive a propeller of a helicopter, may be utilized in aeroderivative applications, or may be attached to a propeller for an airplane.

A flow of air 132 enters air flowpath 114 through annular inlet 116 via an inlet duct 134 during operation of gas turbine engine 100. Inlet duct 134 defines an inlet portion 136 of air flowpath 114. Air 132 flows from inlet duct 134 downstream to compressor 106 where one or more sequential stages of compressor stator vanes 118 and compressor rotor blades 120 coupled to shaft 130 progressively compress air 132. Impeller 122 further compresses air 132 and directs the compressed air 132 into combustion section 108 where air 132 mixes with fuel. Combustor 124 combusts the air/fuel mixture to provide combustion gases 138. Combustion gases 138 flow along air flowpath 114 through HP turbine 110 where one or more sequential stages of turbine stator vanes 126 and turbine blades 128 coupled to HP shaft 130 extract energy therefrom. Combustion gases 138 subsequently flow through LP turbine 111, where an additional amount of energy is extracted through additional stages of turbine stator vanes 126 and turbine blades 128 coupled to LP shaft 131. The energy extraction from HP turbine 110 supports operation of compressor 106 through HP shaft 130, and the energy extraction from LP turbine 111 sports operation of output shaft assembly 103 through LP shaft 131. Combustion gases 138 exit air flowpath 114 of gas turbine engine 100 through exhaust section 112.

It should be appreciated, however, that the exemplary gas turbine engine described herein is provided by way of example only. For example, in other exemplary embodiments, the turbine engine may include any suitable number of compressors, turbines, shafts, etc. Additionally, in other exemplary embodiments, the turbine engine may include any other suitable type of combustor, and may not include the exemplary reverse flow combustor depicted. Further, although the exemplary gas turbine engine is depicted as a turboshaft engine including the output shaft assembly, in other exemplary embodiments, the gas turbine engine may instead be configured as, e.g., a turbojet engine, a turboprop engine, a turbofan engine, etc. Furthermore, although gas turbine engine described above is an aeronautical gas turbine engine for use in a fixed-wing or rotor aircraft, gas turbine engine in other exemplary embodiments, the gas turbine engine may be configured as any suitable type of gas turbine engine that used in any number of applications, such as a land-based, industrial gas turbine engine or an aeroderivative gas turbine engine.

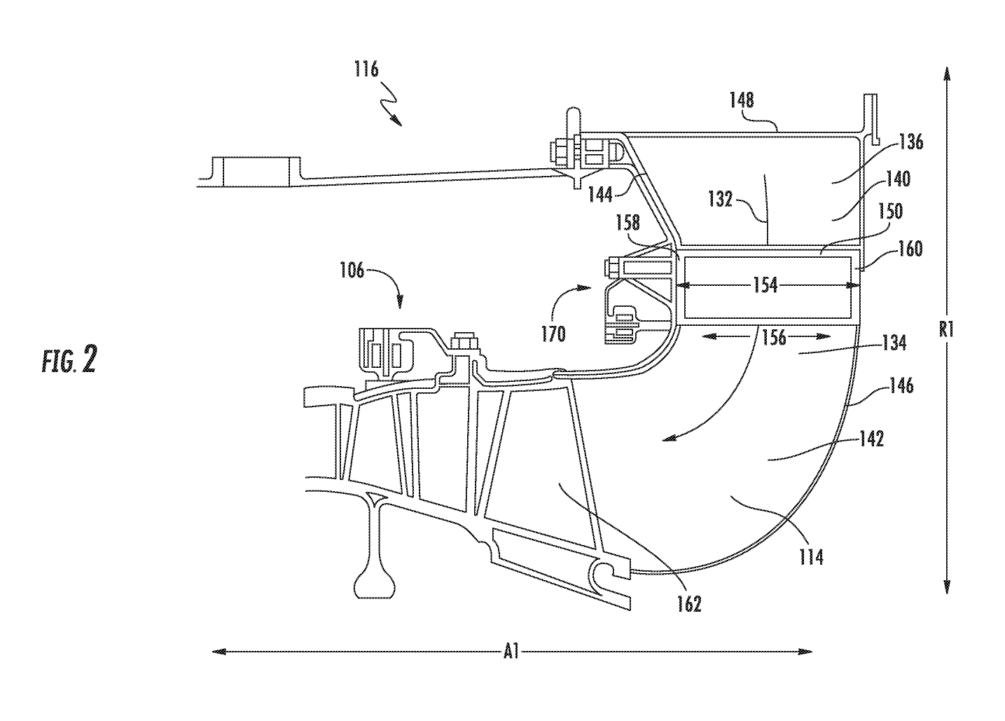

Referring now to FIG. 2, a close-up view of the exemplary inlet duct 134 of the gas turbine engine of FIG. 1 is provided. As discussed above, inlet duct 134 defines an annular inlet 116 and is configured to receive and direct air 132 along air flowpath 114 to compressor 106. Inlet duct 134 defines an inlet portion 136 of air flowpath 114. Inlet duct 134 includes two sections: a radial section 140 and a transition section 142. Radial section 140 is oriented generally along radial direction R1. In this manner, annular inlet 116 is considered a radial inlet. Transition section 142 is positioned downstream of radial section 140 and has a generally arcuate or curved shape. Transition section 142 defines a segment of inlet duct 134 that transitions the duct from a generally radial direction R1 to a generally axial direction A1. Inlet duct 134 is formed by a forward wall 144 and a rear wall 146 extending along inlet portion 136 of air flowpath 114.

Radial section 140 has a mouth 148 configured to receive an incoming flow of air 132. Mouth 148 has a wider diameter than the remaining portion of radial section 140 to better receive ambient air. Once received, air 132 is directed radially inward by radial section 140 of inlet duct 134. Transition section 142 receives the radially inward directed flow of air 132 and directs air 132 to a generally axial direction A1. In this embodiment, transition section 142 directs air 132 in a forward axial direction A1 as gas turbine engine 100 is a “reverse flow” engine. In other embodiments, transition section 142 may direct air 132 in a rearward or aft axial direction A1. Compressor 106 is positioned downstream of transition section 142 along air flowpath 114 and receives the generally axial directed flow of air 132 from transition section 142. Compressor 106 then pressurizes (compresses) air 132.

In FIG. 2, a variable inlet guide vane (VIGV) 150 is illustrated extending at least partially through inlet duct 134 for modifying the flow of air 132 as it travels from mouth 148 of inlet duct 134 downstream to compressor 106. VIGV 150 guides inlet airflow to maximize engine performance and to provide safe engine operating conditions, among other benefits. In particular, VIGV 150 is configured to modify the flow of air 132 to deliver a defined preswirl to compressor 106 in accordance with the compressor's operating condition or point. This, for example, may ensure that an adequate compressor stall/surge margin over a wide operating range is achieved. Although only one VIGV 150 is shown, it will be apparent that inlet duct 134 is annular and that a number of VIGVs 150 may be disposed circumferentially about inlet duct 134 with respect to axial direction A1.

VIGV 150 may extend through inlet duct 134 along different portions of the duct, including through the generally radial oriented radial section 140 and/or the transition section 142 of inlet duct 134. Moreover, VIGV 150 may be oriented within radial section 140 or transition section 142 (or both) in different locations, such as at or adjacent mouth 148 or along a parallel section 152 of inlet duct 134. These noted exemplary embodiments will be discussed in turn.

With reference still to FIG. 2, in one exemplary embodiment, VIGV 150 extends at least partially through inlet duct 134. More specifically, VIGV 150 extends at least partially through radial section 140 of inlet duct 134. VIGV 150 has a vane length 154 that extends in a lengthwise direction 156 between a first vane end 158 and a second vane end 160, the lengthwise direction 156 being substantially parallel with axial direction A1 in this embodiment. First vane end 158 and second vane end 160 may be coupled directly with forward wall 144 and rear wall 146, respectively, or in other known manners, such as by trunnion assemblies coupled to a sync ring or other annularly configured casing that may in turn be coupled to walls 144, 146. As noted previously, where VIGV 150 extends at least partially through inlet duct 134, numerous benefits are realized.

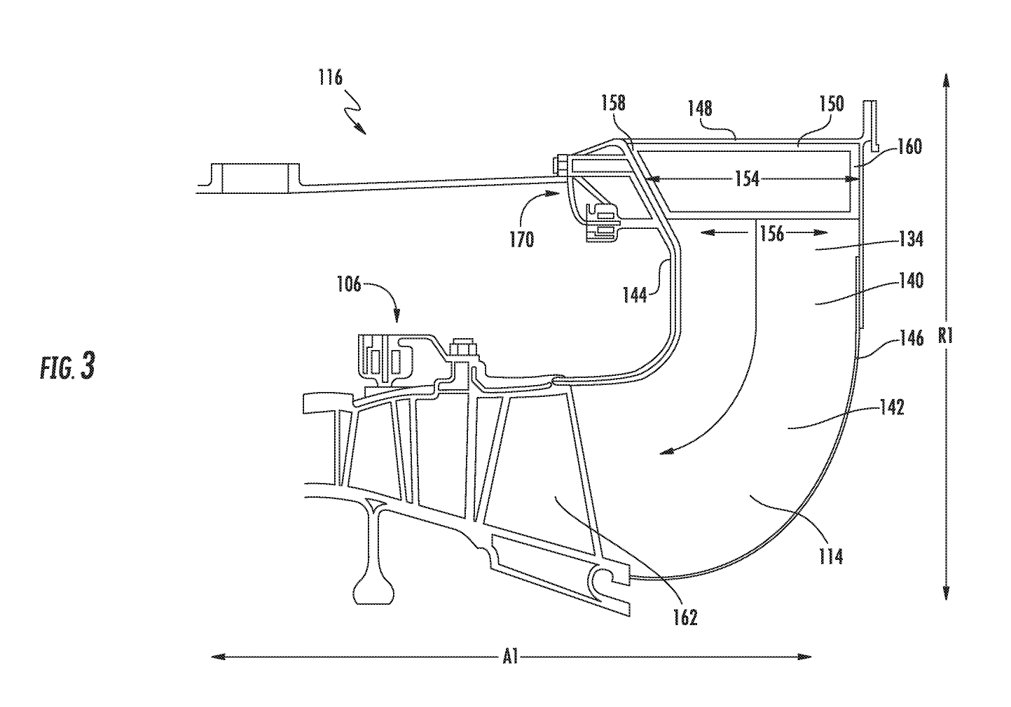

With reference now generally to FIGS. 3 through 7, various other exemplary embodiments of the present disclosure are shown. The exemplary gas turbine engines depicted in FIGS. 3 through 7 may be configured in substantially the same manner as exemplary gas turbine engine described above with reference to FIGS. 1 and 2. Accordingly, the same or similar numbers may refer to the same or similar part. For example, the exemplary gas turbine engines 100 generally include a core turbine engine 101 having a compressor 106 located downstream of an inlet duct 134. The inlet duct 134 generally defines the annular inlet 116 and includes a radial section 140 and a transition section 142. Additionally, a VIGV 150 is provided extending at least partially through the inlet duct 134.

Referring particularly to the embodiment of FIG. 3, as illustrated, VGIV 150 extends at least partially through radial section 140 of inlet duct 134 and is positioned at or adjacent mouth 148. Vane length 154 of VIGV 150 extends from forward wall 144 to rear wall 146 across inlet duct 134 in a lengthwise direction 156, which is substantially parallel with axial direction A1 in this embodiment. As noted above, increasing the separation between VIGV 150 and first rotor blade 162 has numerous benefits.

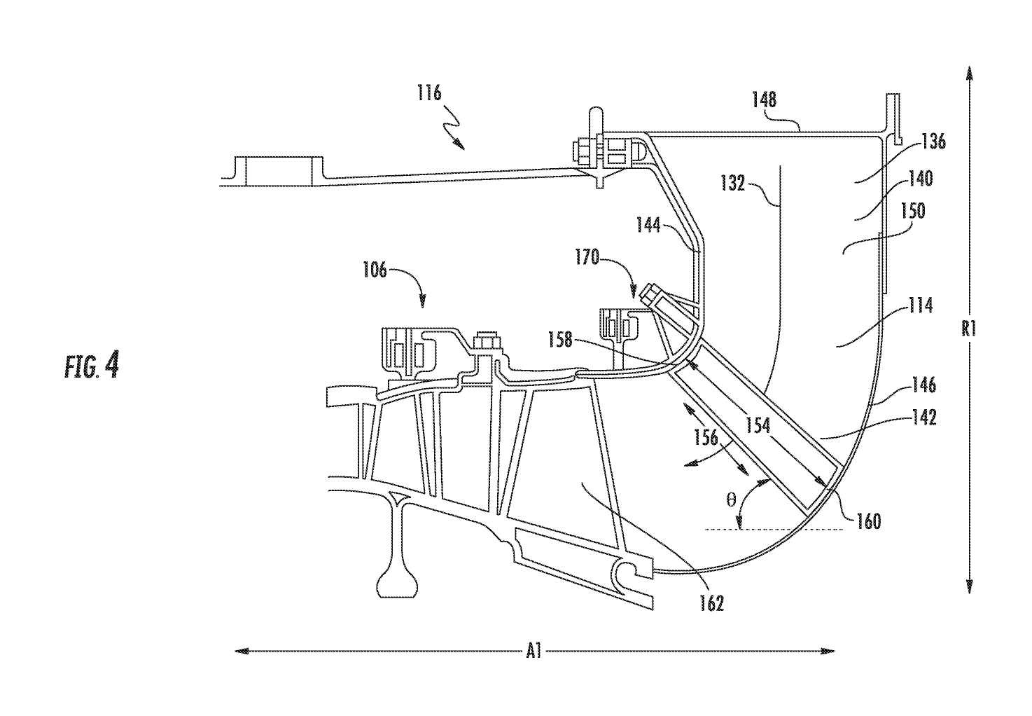

Additionally, referring now particularly to FIG. 4, another exemplary embodiment of the present disclosure is illustrated. In this embodiment, VIGV 150 extends at least partially through transition section 142 of inlet duct 134. Specifically, vane length 154 of VIGV 150 extends from forward wall 144 to rear wall 146 across inlet duct 134 in a lengthwise direction 156 and is oriented at an angle θ with respect to radial direction R1, which in this embodiment is at least about forty-five degrees (45°). However, in other embodiments, the angle with respect to radial direction R1 may be at least about fifty-five degrees (55°), such as at least about sixty-five degrees (65°). In this embodiment, there is separation between VIGV 150 and first rotor blade 162 of compressor 106, which may reduce unfavorable interactions between VIGV 150 and compressor 106. Moreover, in the case where VIGV 150 is hydraulically actuated, for example, positioning VIGV 150 along transition section 142 may reduce a distance the lines and other hydraulic components are required to reach. Moreover, space is freed up along the radial section 140 of inlet duct 134 for other structures, such as struts and other components.

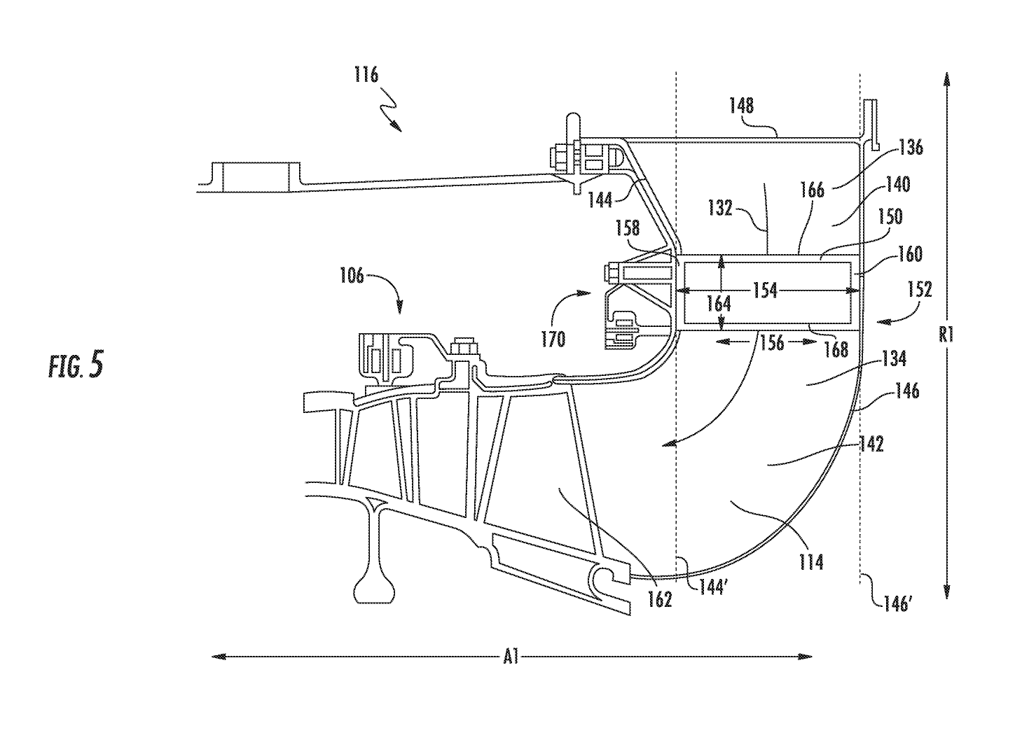

Referring now particularly to the embodiment of FIG. 5, yet another exemplary embodiment of the present disclosure is shown. As illustrated, VIGV 150 extends at least partially through radial section 140 of inlet duct 134. In particular, vane length 154 of VIGV 150 extends from forward wall 144 to rear wall 146 across inlet duct 134 in a lengthwise direction 156 and is oriented substantially parallel with respect to axial direction A1. In this embodiment, radial section 140 includes a parallel section 152. Parallel section 152 is defined by a segment of inlet duct 134 where forward wall 144 and rear wall 146 extend substantially parallel to one another along inlet duct 134. In this manner, where VIGV 150 extends through parallel section 152 of inlet duct 134, the geometry of VIGV 150 can be such that vane ends 158, 160 can be fit along forward wall 144 and rear wall 146 (or a like structure, such as a sync ring) with minimal clearance. In this way, VIGV 150 will not interfere with walls 144, 146 or a like structure when pitched or pivoted or when the geometry of VIGV is varied, such as by a flap or extendable member. Minimal clearance between VIGV 150 and walls 144, 146 or a like structure minimizes a leakage of unguided airflow around a particular vane. The dashed lines 144′ and 146′ of FIG. 5 depict extensions of parallel section 152 showing that the forward and rear walls 144, 146 run parallel to one another along a portion of radial section 140 of inlet duct 134. “Substantially parallel” as that term is used herein to describe parallel section 152 means that the forward and rear walls 144, 146 extend within plus or minus ten degrees (10°) of parallel or at least within manufacturing and/or assembly tolerances, which may be greater than plus or minus ten degrees (10°) of parallel.

In one exemplary embodiment, as shown in FIG. 5, parallel section 152 extends along inlet duct 134 a chord length 164 of VIGV 150, or a distance from a leading edge 166 to a trailing edge 168 of VIGV 150. This allows the geometry of vane ends 158, 160 to be fit along forward wall 144 and rear wall 146 (or a like structure) with minimal clearance along the entire chord length 164 of each vane. Thus, airflow leakage around VIGV 150 is minimized.

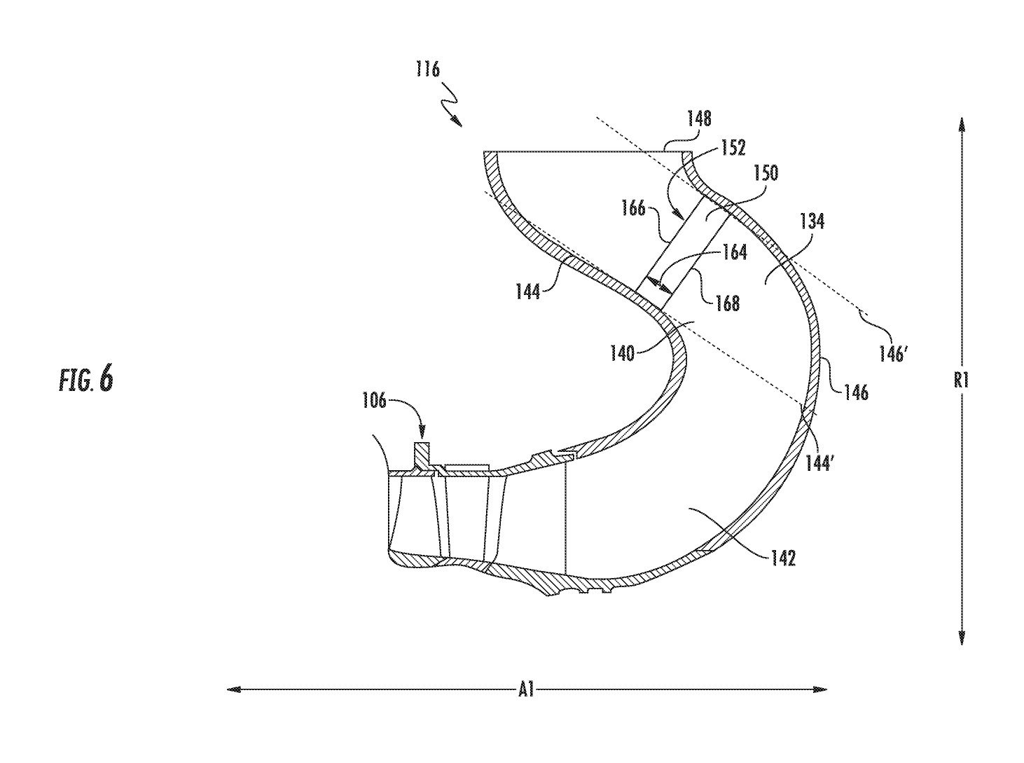

Referring now particularly to the embodiment of FIG. 6, still another exemplary embodiment of the present disclosure is shown. For the embodiment of FIG. 6, the inlet duct 134 also includes a parallel section 152 with the VIGV 150 extending therethrough. However, for the embodiment of FIG. 6, the parallel section 152 is not oriented along the radial direction R1. Additionally, for the embodiment of FIG. 6, VIGV 150 extends through parallel section 152 and is not oriented substantially parallel with axial direction A1. In other words, parallel section 152 may extend at any suitable location along radial section 140 or transition section 142 so long as forward wall 144 and rear wall 146 are substantially parallel to one another, or that the walls of a like structure are positioned substantially parallel to one another. In other embodiments, as noted above, parallel section 152 extends along the chord length 164 of each VIGV 150. And in particular, parallel section 152 extends along the entire chord length 164 of each VIGV 150. The dashed lines 144′ and 146′ of FIG. 6 depict extensions of parallel section 152 showing that the forward and rear walls 144, 146 run a parallel to one another along a portion of inlet duct 134.

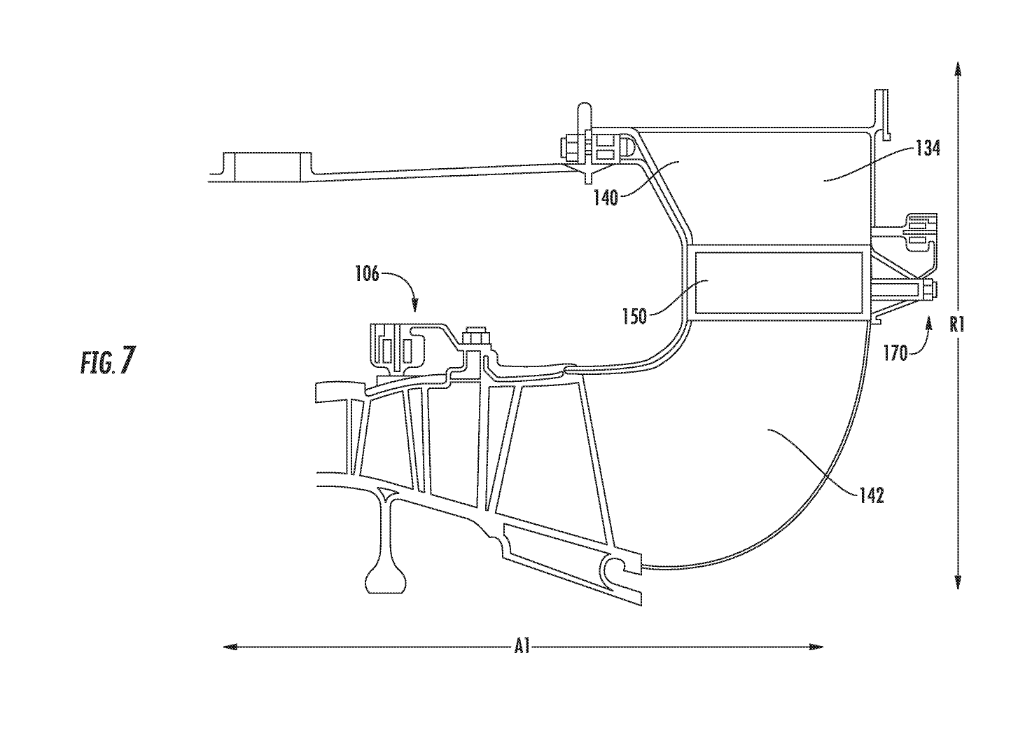

Referring now particularly to the exemplary embodiment of FIG. 7, VIGV 150 is positioned within radial section 140 of inlet duct 134. However, in contrast to the exemplary embodiment depicted in FIG. 2, and described above, an actuator 170 of VIGV 150 is shown aft of inlet duct 134. In FIG. 2, actuator 170 is shown forward of inlet duct 134. When actuator 170 is positioned aft of inlet duct 134, more space is provided radially outward of compressor 106 for other assemblies or components. When actuator 170 is positioned forward of inlet duct 134, more space for an assembly or other components is provided aft of inlet duct 134. Accordingly, where VIGV 150 extends through radial section 140 of inlet duct 134, flexibility is provided in positioning of actuator 170.

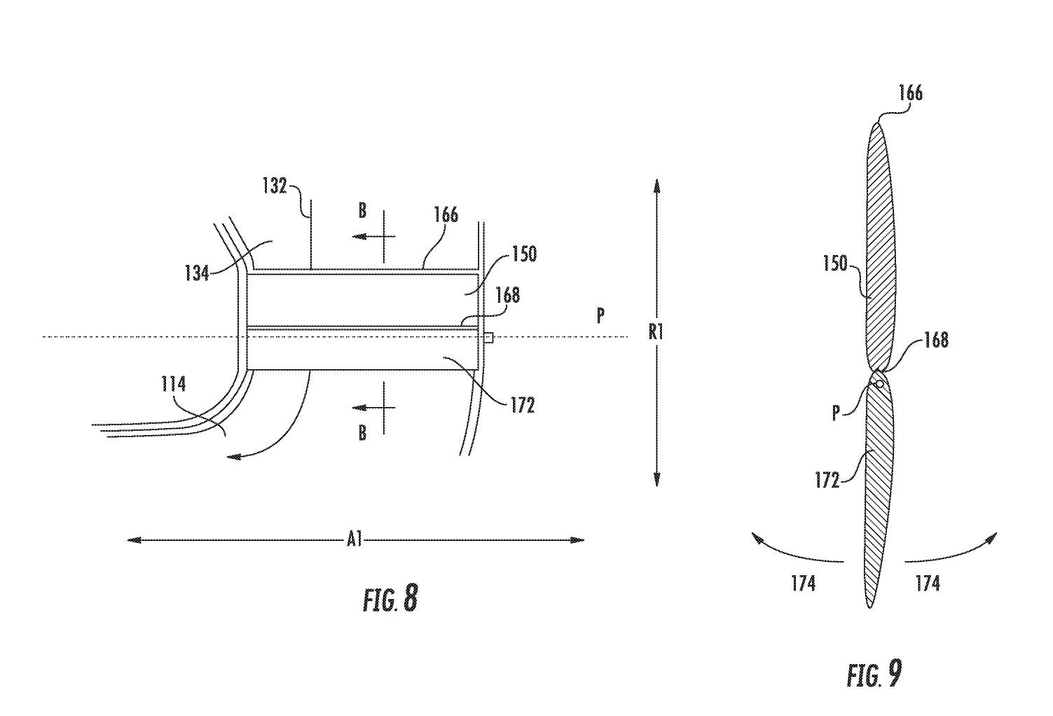

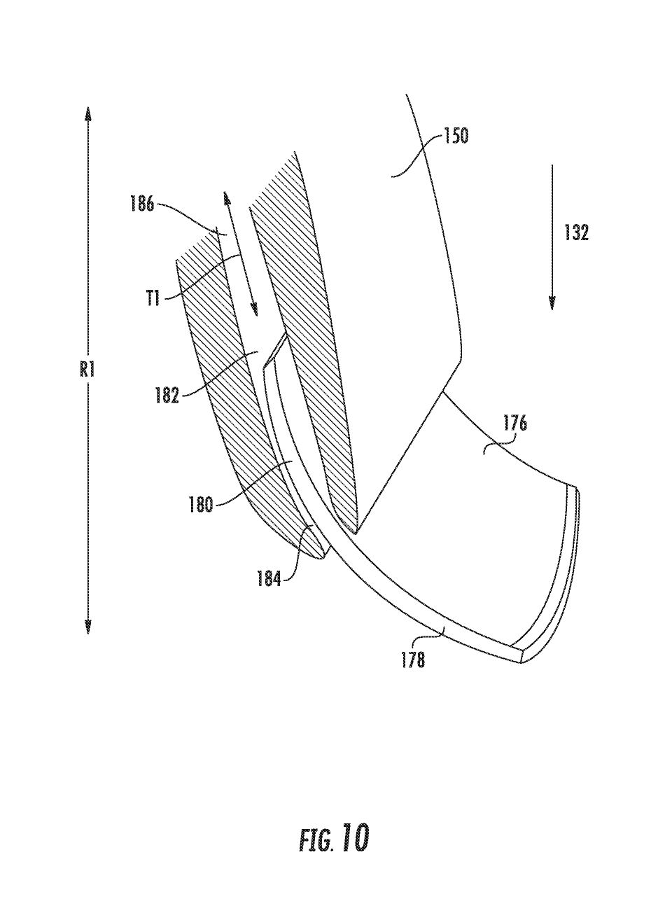

With reference now to FIG. 8, a close-up view is provided of a VIGV 150 in accordance with an exemplary embodiment of the present disclosure. In certain exemplary embodiments, one or more of the VIGVs 150 depicted in FIGS. 1 through 7 may be configured in substantially the same manner as exemplary VIGV 150 of FIG. 8. In certain exemplary embodiments of the present disclosure, VIGV 150 may be a variable geometry VIGV. The variable geometry can be achieved by use of a flap 172 positioned adjacent to trailing edge 168 of VIGV 150. Flap 172 may be adjustable about a pivot axis P, which in this embodiment is substantially parallel to axial direction A1, to provide a range of positions for variably deflecting or modifying the flow of air 132 along air flowpath 114. Flap 172 is configured to pivot from a nominal or zero deflection position to a range of deflection positions. For example, flap 172 may be configured to be positioned in deflection positions ranging from zero to seventy degrees (70°) with respect to the nominal deflection position (shown in FIG. 9).

FIG. 9 is a section view taken along the lines B-B of FIG. 8. Flap 172 is positioned downstream of VIGV 150 and adjacent trailing edge 168 of VIGV 150. As shown by pivot arrows 174, flap 172 may be pivoted about pivot axis P to deflect or modify air 132 as it moves along air flowpath 114.

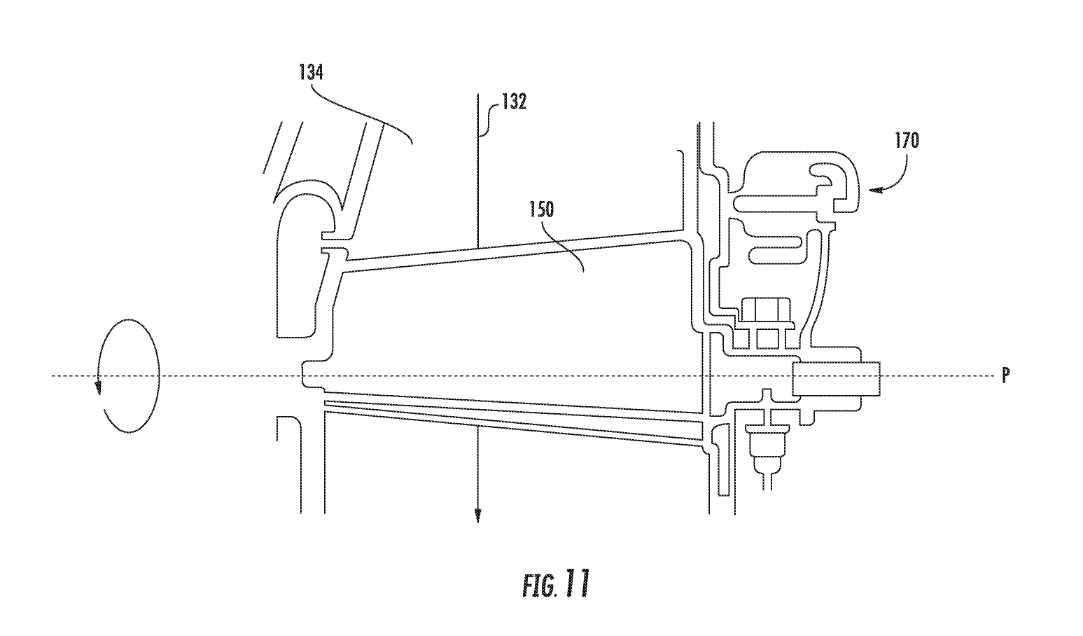

It should be appreciated, however, that in other exemplary embodiments, VIGV 150 may have any other suitable variable geometry configuration. For example, referring to FIG. 10, a close-up view of an exemplary variable geometry VIGV 150 in accordance with another embodiment of the present disclosure is provided. It should be appreciated, that as used herein, the term “VIGV” refers generally to any component extending through the air flowpath at a location upstream of the compressor. Accordingly, any struts or other similar components may be considered VIGVs as that term is used herein. The exemplary VIGV 150 of FIG. 10 also extends at least partially through inlet duct 134 and includes a retractable member 176. Retractable member 176 is configured to translate substantially along a translating axis T1 to modify a flow of air 132 flowing through inlet duct 134. In this embodiment, translating axis T1 is generally parallel with radial direction R1. Retractable member 176 is configured to retract or extend from VIGV 150 depending on the operating line of compressor 106.

Retractable member 176 includes a curved portion 178 and a planar portion 180. Channel 182 includes a curved channel portion 184 and a planar channel portion 186. Curved channel portion 184 is configured to receive curved portion 178 of retractable member 176 and planar channel portion 186 is configured to receive planar portion 180 of retractable member 176. Where less deflection or modification of air 132 is desired, retractable member 176 is retracted within channel 182. Where more deflection or modification of air 132 is desired, retractable member 176 is extended outwardly (i.e., in a generally downstream direction) to modify air 132 flowing through inlet duct 134. Accordingly, the desired preswirl can be developed. Retractable member 176 may be actuated by any suitable means, such as by electric or hydraulic actuators.

Moreover, in still other exemplary embodiments of the present disclosure, the VIGV 150 may have any other suitable variable geometry. For example, FIG. 11 shows VIGV 150 in accordance with still another exemplary embodiment of the present disclosure extending through inlet duct 134 and configured to rotate about a pivot axis P. VIGV 150 is rotatably mounted on radial spindles (not shown) or the like such that VIGV 150 may rotate from a closed position to an open position, and vice versa, depending on the operational conditions of compressor 106. In FIG. 11, VIGV 150 is shown in a fully open position. In the fully open position, VIGV 150 minimally deflects/modifies air 132. To rotate to a closed positioned (not shown), VIGV 150 is rotated about ninety degrees from the open position about pivot axis P. In the closed position, VIGV 150 provides maximum deflection or modification of air 132. It will be appreciated that other means may be used to vary geometry of VIGV 150.

Furthermore, it will be appreciated, that VIGVs may instead be configured to modify airflow in other manners. For instance, VIGVs may modify airflow in a number of ways, including by use of fluidics or fluidic bending. In fluidics or fluidic bending, pressurized air from the compressor section is routed back into the airflow of the inlet and introduced into the inlet duct. The pressurized air could be introduced to the inlet duct through holes or slots in a VIGV or strut, for example.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turbine engine defining an air flowpath, an axial direction, and a radial direction, the turbine engine comprising:
a compressor rotatable about the axial direction for pressurizing an airflow;
an inlet duct in airflow communication with the compressor and positioned upstream of the compressor, the inlet duct defining an inlet portion of the air flowpath, the inlet portion of the air flowpath oriented generally along the radial direction; and
a variable inlet guide vane extending at least partially through the inlet duct for modifying the airflow through the inlet duct to the compressor.

2. The turbine engine of claim 1, wherein the inlet duct comprises a radial section oriented generally along the radial direction, the variable inlet guide vane extending at least partially through the radial section of the inlet duct.

3. The turbine engine of claim 1, wherein the inlet duct comprises:
a radial section oriented generally along the radial direction;
a transition section positioned downstream of the radial section and configured to direct airflow from generally along the radial direction to generally along the axial direction; and
wherein the variable inlet guide vane extends at least partially through the transition section of the inlet duct.

4. The turbine engine of claim 1, wherein the variable inlet guide vane defines a vane length along a lengthwise direction, the lengthwise direction extending substantially parallel with the axial direction, wherein the variable inlet guide vane extends along the lengthwise direction at least partially through the inlet duct.

5. The turbine engine of claim 1, wherein the variable inlet guide vane defines a vane length along a lengthwise direction, the lengthwise direction defines an angle with the radial direction less than about forty-five degrees, wherein the variable inlet guide vane extends along the lengthwise direction at least partially through the inlet duct.

6. The turbine engine of claim 1, wherein the turbine engine further comprises a plurality of variable inlet guide vanes and an actuator, the plurality of variable inlet guide vanes configured to be actuated by the actuator; and wherein the actuator is positioned aft of the inlet duct.

7. The turbine engine of claim 1, wherein the turbine engine further comprises a plurality of variable inlet guide vanes and an actuator, the plurality of variable inlet guide vanes configured to be actuated by the actuator; and wherein the actuator is positioned forward of the inlet duct.

8. The turbine engine of claim 1, wherein the variable inlet guide vane defines a leading edge and a trailing edge, and wherein the variable inlet guide vane comprises an adjustable flap at the trailing edge for modifying the airflow through the inlet duct to the compressor.

9. The turbine engine of claim 1, wherein the variable inlet guide vane defines a leading edge and a trailing edge, and wherein the variable inlet guide vane comprises a retractable member at the trailing edge that is configured to translate between a retracted position and an extended position for modifying the airflow through the inlet duct to the compressor.

10. The turbine engine of claim 1, wherein the variable inlet guide vane defines a pivot axis, and wherein the variable inlet guide vane is configured to rotate about the pivot axis for modifying the airflow through the inlet duct to the compressor.

11. The turbine engine of claim 1, wherein the inlet duct is annularly disposed about a central axis, the central axis disposed along the axial direction, the inlet duct comprising:
a forward wall and a rear wall forming the inlet duct and extending along the inlet portion of the air flowpath;
a parallel section positioned along the inlet duct and defined where the forward wall and the rear wall extend substantially parallel to one another; and
wherein the variable inlet guide vane extends at least partially through the parallel section of the inlet duct.

12. The turbine engine of claim 11, wherein the variable inlet guide vane has a leading edge and a trailing edge, a chord length defined between the leading edge and the trailing edge, wherein the forward wall and rear wall of the parallel section extend substantially parallel to one another substantially along the chord length of the variable inlet guide vane.

13. A turbine engine defining an air flowpath, an axial direction, and a radial direction, the turbine engine comprising:
a compressor rotatable about the axial direction for pressurizing an airflow;
an inlet duct in airflow communication with the compressor and positioned upstream of the compressor, the inlet duct defining an inlet portion of the air flowpath, the inlet duct comprising:
a radial section oriented generally along the radial direction;
a transition section extending between the radial section and the compressor and configured to direct the airflow from generally along the radial direction to generally along the axial direction; and
a variable inlet guide vane configured to modify the airflow to the compressor, the variable inlet guide vane defining a lengthwise direction extending generally parallel to the axial direction, and wherein the variable inlet guide vane extends in the lengthwise direction at least partially in at least one of the radial section and the transition section of the inlet duct.

14. The turbine engine of claim 13, wherein the variable inlet guide vane has a leading edge and a trailing edge, and wherein the variable inlet guide vane comprises a retractable member at the trailing edge that is configured to translate between a retracted position and an extended position for modifying the airflow through the inlet duct to the compressor.

15. The turbine engine of claim 13, wherein the lengthwise direction defines an angle with the radial direction less than about forty-five degrees, wherein the variable inlet guide vane extends along the lengthwise direction at least partially through the inlet duct.

16. The turbine engine of claim 13, wherein the inlet duct is annularly disposed about a central axis, the central axis disposed along the axial direction, the inlet duct comprising:
a forward wall and a rear wall forming the inlet duct and extending along the inlet portion of the air flowpath;
a parallel section positioned along the inlet duct and defined where the forward wall and the rear wall extend substantially parallel to one another; and
wherein the variable inlet guide vane extends at least partially through the parallel section of the inlet duct.

17. A turbine engine defining an air flowpath, an axial direction, and a radial direction, the turbine engine comprising:
a compressor rotatable about the axial direction for pressurizing an airflow;
a combustor positioned downstream of the compressor along the air flowpath;
a turbine positioned downstream of the combustor along the air flowpath;
an exhaust section positioned downstream of the turbine along the air flowpath;
an inlet duct in airflow communication with the compressor and positioned upstream of the compressor, the inlet duct defining an inlet portion of the air flowpath and having a forward wall and a rear wall extending along the inlet portion, the inlet portion of the air flowpath oriented generally along the radial direction; and
a variable inlet guide vane assembly having a plurality of vanes disposed circumferentially about a central axis, the central axis being disposed along the axial direction, each vane extending generally along the axial direction from the forward wall to the rear wall of the inlet duct.

18. The turbine engine of claim 17, wherein each vane extends substantially parallel with the axial direction from the forward wall to the rear wall of the inlet duct.

19. The turbine engine of claim 17, wherein each vane extends from the forward wall to the rear wall of the inlet duct within at least about forty-five degrees of the radial direction.

20. The turbine engine of claim 17, wherein the inlet duct comprises: a parallel section defined where the forward wall and the rear wall extend substantially parallel to one another, each vane extending within the parallel section from the forward wall to the rear wall of the inlet duct.
